(19) United States
(12) Patent Application Publication
(10) Pub. No.: US 2006/0239500 A1
(43) Pub. Date: Oct. 26, 2006

(54) Method of and apparatus for reversibly adding watermarking data to compressed digital media files

(76) Inventors: Thomas W. Meyer, Haiku, HI (US); Josslyn Motha Meyer, Haiku, HI (US)

Correspondence Address: RINES & RINES, 24 Warren St., CONCORD, NH, 03301, US

(21) Appl. No.: 11/110,537

(22) Filed: Apr. 20, 2005

(51) Int. Cl. G09C 5/00; G06K 9/00; H04L 9/00; G06K 9/36

(52) U.S. Cl. 382/100; 382/232; 380/54; 713/176

(57) ABSTRACT

A novel technique for embedding a reversible watermark into digital media files, and then removing this watermark, in whole or in part, at some later date, without access to the original media file, which may consist of such media types as audio, image, video, 3-D and the like; such watermarks being primarily intended for, though not limited to, the introduction by a reversible mathematical operation of perceptually significant elements, including but not limited to pseudorandom noise, such that the degraded media is suitable merely for demonstration or trial purposes, and with the watermark resistant to removal without proper authorization; but with authorization, can then be removed from the media file to prepare it for its ultimate high-quality use.

### FIELD OF INVENTION

The general field of application of the present invention involves techniques for embedding watermarks into digital media files; the invention being more particularly directed to the embedding of a reversible watermark into such digital media files, and then removing such a watermark, in whole or in part, at some later date, without access to the original media file. Among such media type files are audio, image, video, 3-D and the like; such watermarks being primarily intended for, though not limited to, the introduction of perceptually significant elements into the media, such as pseudorandom noise, tonal elements, or vocal elements, such that the media are degraded but suitable merely for demonstration or trial purposes. The watermark is resistant to removal without proper authorization and these perceptually significant elements can then be removed from the media to prepare it for its ultimate high-quality use.

### BACKGROUND OF INVENTION

The use of peer-to-peer file sharing systems such as Napster, Grokster, Kazaa, and BitTorrent has grown greatly in recent years, primarily due to the wide community of users interested in sharing digital media with one another. Recent developments in peer-to-peer sharing, such as podcasting, where users create pre-mixed downloadable streams of music, as well as the providing of the ability for people to easily share files in public settings through, for example, 802.11 and Bluetooth, have demonstrated that users have an increasing desire to share digital media with one another.

Unfortunately for the content creation industry, much of that digital media is being shared without the payment of appropriate fees. Because of this, the content creation industry has strongly encouraged the development of Digital Rights Management (DRM) techniques to technologically regulate how files are shared. In the licensing mechanism known as “superdistribution,” first described by Ryoichi Mori, people are allowed to share media with each other, but must receive a separate license in order to be able to freely enjoy the content:

Mori, Ryoichi, and Masaji Kawahara, “Superdistribution: The Concept and the Architecture,” The Transactions of the IEICE; Vol. E 73, No. 7 July 1990, Special Issue on Cryptography and Information Security.

There are difficulties, however, with the two previous main approaches to such superdistribution: watermarked formats, and encrypted envelopes.

If the music is distributed unsecured in an open format, such as mp3, which contains an embedded DRM watermark, the supplier is dependent on every link in the chain being perfectly secure in order to enforce the DRM. Since the music is typically stored unencrypted, a hacker can still bypass the DRM and get a full-quality version of the song from the media player storage.

On the other hand, if the media are distributed in a proprietary, secure envelope format, very few media players will be able to play it without upgrading, etc. This “all or nothing” approach slows the adoption of the many proprietary secure media formats that have been developed over the years.

The approach of the present invention, accordingly, is designed to counter the weaknesses of these two prior approaches, by providing a secure container, implemented using open standards, which is nevertheless partially playable in an unsecured or unmodified environment.

Prior watermarking techniques typically embed human-perceptible or machine-readable information into a media stream, so that this embedded information is robust to the degradation and manipulation of the media. In the normal use scenario, a media producer will add a watermark to the media file in order to be able to track the following distribution of that file, and to discourage unauthorized use. Typical watermarking techniques rely on gross characteristics of the signal being preserved through common types of transformations applied to a media file.

Unlike the system of the present invention, however, they are explicitly designed not to be reversible, and, indeed, greatly degrade the quality of the file if they should be removed.

A survey of techniques for multimedia data labeling, and particularly for copyright labeling using watermark is presented by Langelaar, G. C. et al. in “Copy Protection For Multimedia Data based on Labeling Techniques”(http://www-it.et.tudelft.nl/html/research/smash/public/benlx96/benelux_cr.html).

The earlier cited Langelaar et al publication, in turn, references and discusses the following additional prior art publications:
J. Zhao, E. Koch: “Embedding Robust Labels into Images for Copyright Protection”, Proceedings of the International Congress on Intellectual Property Rights for Specialized Information, Knowledge and New Technologies, Vienna, Austria, August 1995;
E. Koch, J. Zhao: “Towards Robust and Hidden Image Copyright Labeling”, Proceedings IEEE Workshop on Nonlinear Signal and Image Processing, Neos Marmaras, June, 1995; and
F. M. Boland, J. J. K O Ruanaidh, C, Dautzenberg: “Watermarking Digital Images for Copyright Protection”, Proceedings of the 5th International Conference on Image Processing and its Applications, No. 410, Endinburgh, July, 1995

An additional article by Langelaar also discloses earlier labeling of MPEG compressed video formats:
G. C Langelaar, R. L. Lagendijk, J. Biemond: “Real-time Labeling Methods for MPEG Compressed Video,” 18th Symposium on Information Theory in the Benelux, 15-16 May 1997, Veldhoven, The Netherlands.

These Zhao and Koch, Boland et al and Langelaar et al disclosures, while teaching encoding technique approaches having partial similitude to components of the techniques employed by the present invention, as will now be more fully explained, are not, however, either anticipatory of, or actually adapted for providing for the removal of such data at a later date, without drastically impairing the quality of the media and the usability thereof.

Considering, first, the approach of Zhao and Koch, above-referenced, they embed a signal in an image by using JPEG-based techniques. ([JPEG] Digital Compression and Coding of Continuous-tone Still Images, Part 1: Requirements and guidelines, ISO/IEC DIS 10918-1. They first encode a signal in the ordering of the size of three coefficients, chosen from the middle frequency range of the coefficients in an 8-block or octet DCT. They divide eight permutations of the ordering relationship among these three coefficients into three groups: one encoding a ‘1’ bit (HML, MHL, and HHL), one encoding a ‘0’ bit (MLH, LMH, and LLH), and a third group encoding “no data” (HLM, LHM, and MMM). They have also extended this technique to the watermarking of video data. While their technique is robust and resilent to modifications, they do not, however, provide for the removal of such data. As will later more fully be explained, this is a disadvantage overcome by the present invention.

As for Boland, Ruanaidh, and Dautzenberg, they use a technique of generating the DCT Walsh Transform, or Wavelet Transform of an image, and then adding one to a selected coefficient to encode a “1” bit, or subtracting one from a selected coefficient to encode a “0” bit. This technique, although at first blush somewhat superficially similar in one aspect of one component of the present invention, has the very significant limitation obviated by the present invention, that information can only be extracted by comparing the encoded image with the original image. This means that a watermarked and a non-watermarked copy of any media file must be sent simultaneously in order for the watermarking to work. This is a rather severe limitation, completely overcome by the current invention. In addition to being impossible to verify the existence of a watermark without a copy of the original media, it is also impossible to remove the watermark using their technique.

Various forms of perceptually imperceptible watermarking were also developed and tested as part of the Secure Digital Music Initiative, but were subsequently abandoned during pre-release testing, after songs were quickly hacked to remove the watermark, though this was at the cost of further degrading the quality of the music—again unlike in the present invention.

There are many implementations of secure envelopes to provide DRM techniques. Typically, they create a container file which contains an encrypted media stream, and which can be unlocked with an appropriate license key. Unlike the current invention, however, they cannot be played in any form when the user either has an incompatible player, or is not licensed to play that content. Often, the players allow for limited previewing of the content without a license, but such previewing nevertheless requires a proprietary player capable of reading the container file and extracting the media. This once more is contrasted from the present invention, where the content is stored in a standard media format, capable of being read and played at lower quality without proprietary means.

The invention herein might be described as a middle path between the two classes of prior techniques—watermarking and secure envelopes, novelly combining the ubiquity of open formats with the power of an encrypted envelope. This novel “try before you buy” approach does not even require the user to have a special player to try the music.

A typical use scenario, might be as follows. Bob meets Alice at a coffee shop, and is impressed with the Balinese music collection on her mp3 player, so downloads all these songs onto his cell phone. When Bob plays them later, the first 30 seconds of each song play well enough for him to hear the quality of the recording, but after that, the embedded watermarked noise reduces the quality to below that of an AM radio broadcast. However, if he likes a song and purchases a license to it, the entire song is restored, and plays at its original high quality.

The present invention creates a standard media file that has an audible, reversible watermark added. Upon appropriate licensing, this watermark can either be temporarily removed during the decoding and playback process, or can be permanently removed from the media file. Generally, for security reasons, in a situation which allows for further sharing of the media file, the watermark will be temporarily removed only on the in-memory version, as part of the playback process.

A system described in European patent application EP 1 465 157 A1 also implements a similar system to that described here, which is capable of inserting an apparent watermark and later removing it. Unlike the system of the present invention, however, which uses reversible mathematical operations to insert and remove the watermark, it relies on the copying of saved data from watermarked sections to unused portions of the audio file; for example, to ancillary portions. The drawbacks of that system are that the file must necessarily increase substantially in size to accommodate this saved data. In that specific approach, changing (adding) about 100 bytes per frame, or 32 kilobits/second of size to the data file to store this.

The present invention, on the other hand, does not have the limitation of requiring that this “undo” information be saved, since the watermark is added by using reversible operations. In the system of the invention, only a few bytes per frame (compared to 100 bytes per frame in said European patent application system) are necessary to be stored to recreate the noise envelope so that it can be removed.

Because the number of bytes needed is so much smaller, the present invention can take advantage of techniques such as those described in applicant's earlier U.S. Pat. Nos. 6,748,362 (dealing with embedding data in media files) and 6,768,980 (dealing with steganographic embedding of data in digital measurements) to embed those few bytes of data, without needing to increase the file size at all. Additionally, while the system of the present invention is capable of embedding data in a multitude of media formats, prior systems are limited to spectrally-encoded audio signals, such as mp3, only.

In World Intellectual Property Organization application WO 99/55089, still a different type of system is described which “scrambles” the bits of a music file by interchanging portions of an audio sample with other nearby portions in the file. This technique again differs from the present invention, which does not rely on interchanging data at all. The following publications, however, do describe a system with similar intent to the present invention, with a technique they describe as “Bitwise XOR of least significant bits of the quantized spectral coefficients with a key-dependent pseudo random number sequence.”

Herre, Jürgen and Eric Allamanche, “Compatible Scrambling of Compressed Audio,” Proceedings 1999 IEEE Workshop on Applications of signal Processing to Audio and Acoustics, New Paltz, N.Y., Oct. 17-20, 1999.

Unlike the technique of the present invention, though, this compatible scrambling technique is not described as using the step of analyzing the content of the media, so as to add the proper amount of noise to the media, and so do not overcome the limitation that they are unable to vary the amount of noise introduced dynamically. Instead, they describe the use of an alternate method, “reordering of spectral coefficients,” which they say “produced the most uniform distortion for all types of audio material.”

They confirm this in a subsequent paper, where they describe the same technique as “Bitwise XOR with Spectral Coefficients”:
Allamanche, Eric, and Jürgen Herre, “Secure Delivery of Compressed Audio by Compatible Bitstream Scrambling,” AES 108th Convention, Paris, 2000 February 19-22, Preprint 5100.

In the system described therein, on pp. 8-9 of that document, they state that “subjective informal testing of the perceptual degradations showed that the distortions produced for incorrect descrambling depend on the type of audio material encoded and may, for some cases, not be strong enough to discourage illegal listening.” They were not able to overcome this problem, so their final solution proposes a different system involving the swapping of various coefficients. In accordance with the present invention, a significant, novel and non-obvious improvement is provided which addresses this problem; namely, analyzing the media properties, creating a customized watermark designed to be perceptually intrusive in the context of that media, and then storing the watermarking parameters, as later more fully detailed.

Still another patent application EP 1 189 372 A2 teaches a system wherein a noise signal, which is at “a level of sound perceivable by the human sense of hearing signal,” is added to an existing signal. In their system, an audio signal is separated out into a number of frequency bands. The “telephone voice band” of 300-3,400 Hz is separated out to have noise signal parameters stored in it using imperceptible watermarking techniques. The remaining information has a noise signal added to it based on these noise signal parameters.

Although this may appear superficially similar to the system of the present invention, there are significant differences. They do not teach, as do applicants, how to limit the added noise signal to avoid having media compressed with a frequency-domain codec (such as mp3) affected by the addition of the noise signal, during the encoding process. They must also embed the noise signal parameters in untouched frequency bands, whereas the present invention is able to embed the noise signal parameters in the same frequency bands where the noise signal itself is embedded. They also only teach the embedding of a single “third key”, which appears to be their term for the noise signal parameters, in the song (paragraphs 78-79, 116, and 122), so do not teach how to have noise signal parameters, which change from moment to moment throughout the song.

The techniques taught as part of the present invention, furthermore, as later detailed may be used with any type of digital media file, including music formats such as but not limited to CD, mp3, AAC, ATRAC, WMA, GSM, and CDMA; image formats such as but not limited to JPEG, TIFF, and GIF; video formats such as but not limited to MPEG, MPEG-2, H.264, and VC-1; and 3D formats such as but not limited to VRML, Web3D, and volumetric data.

One area of great use for this invention is to enable content providers to release music and video over the Internet such that it can be freely shared among members of the target audience, while still providing for these content providers to be remunerated for their works. In such an environment, a particular embodiment of this invention targeting the distribution of mp3 format files may provide for the content provider to insert an apparent, audible and disruptive watermark after the first 30 seconds of song playback, such that it is still possible for the user to hear the music and determine whether he or she is interested in purchasing the music. If so, the user attains a license, which contains a cryptographic key, through some external licensing mechanism. Upon receipt of a valid license for the content, this invention then decrypts and removes the watermark during playback of the music using techniques taught later in this document.

It is necessary for this apparent, audible, and disruptive watermark, which is herein termed as a “noisemark,” to be sensitive to the dynamics of the song—for example, the amount of added noise which disrupts a symphony would not even be noticed in a heavy metal song. Additionally, for modem compression algorithms using frequency-domain compression techniques and adaptive compression, such as mp3, the frequency range and characteristics of such a noisemark should be recalculated every frame, for technical reasons, since it is difficult to maintain a high-quality output with a truly reversible watermark unless the noise introduced always has the same frequency profile as the music itself, as will be explained later in this application.

In one embodiment, this invention can use data embedding techniques such as those described in applicants’ before-mentioned earlier U.S. Pat. Nos. 6,748,362 and 6,768,980, which create a second data channel in a digital media stream. This second data channel can contain not only the reversible watermark described in this invention, but also embedded rich media, such as transactions, ads, interactive music videos, and the like. Instead of requiring a paid license, the media player can enforce viewing rich media content as a condition of licensing, to remove the noisemark and listen at full quality.

The current invention also interoperates with and is fully compatible with robust watermark DRM solutions, since the reversible watermark can ride on top of many types of robust watermark. Additionally, since what is created is a standard digital media stream, data envelope DRM mechanisms such as Apple Computer's “Fairplay” can transparently encapsulate it. This allows the creation of rich new licensing mechanisms which combine the strengths of all types of DRM approaches.

Another anticipated use of this invention is to provide perceptible less removable watermarks for media tracking purposes. For example, it is useful for a photographer to be able to submit watermarked photographs to a newspaper for review, but for that photographer also to be able to license removal of the watermarks once the agency has decided to purchase them for publication. This is also useful for firms selling stock media, so that they can authorize restoration of the media to a high-quality version, and do not have to ship out substitute, Un-watermarked or higher quality media to be used for final output.

### OBJECTS OF INVENTION

It is accordingly a primary object of the present invention to provide a new and improved method of and apparatus for reversibly adding watermarks to media data, which shall not be subject to the above-described and other limitations and disadvantages of prior art approaches, through the novel use of watermarks that are added through reversible mathematical operations (such as addition and exclusive or (XOR)), wherein enough parameters are encoded in the watermarked media file to allow for the watermark to be regenerated, and then removed through reversing the aforementioned mathematical operation.

Other and further objects will be explained hereinafter and are more particularly delineated in the appended claims.

### SUMMARY

In summary, however, from one of its broader or generic aspects, the invention embraces the method of and apparatus for adding a reversible watermark to media data, that comprises, analyzing the media data to determine which watermarking elements are most suitable for adding, based on the intended use of the media and the codec with which it is being compressed; creating a watermark based on these parameters; adding the watermark to the media file using a reversible mathematical operation; encoding all necessary parameters for later use; either into the media, through steganographic means or additional data channels, or through storing in an external database; upon the user receiving the media, playing it with the watermark until a proper license is received; and if so received, recreating the watermark and then reversing the mathematical operation thereby to remove the watermark.

Best mode and preferred embodiments, techniques and designs for implementing the invention are hereinafter explained in detail.

### DRAWINGS

The invention will now be described in connection with the accompanying drawings, which illustrate the following:

FIG. 1 is a block and flow diagram illustrating an overview of the watermark embedding process and system, operating in accordance with a preferred embodiment of the invention;

FIG. 2 is a similar diagram presenting an overview of the playback of the media embedded with the watermark of FIG. 1, on a licensed media player or viewer;

FIG. 3 is a modified version of FIG. 1, showing specifically how this invention is used with mp3 audio encoding.

FIG. 4 is a modified version of FIG. 1, showing specifically how this invention is used with MPEG video encoding.

FIG. 5 is a modified version of FIG. 1, showing specifically how this invention is used with JPEG image encoding.

FIG. 6 illustrates a basic example of the licensing process;

FIG. 7 illustrates the analysis of the spectral envelope when this invention is used with frequency-domain codecs;

FIG. 8 shows how this analysis is used to create an appropriate watermarking signal that will not greatly affect the compression process of frequency-domain codecs;

FIG. 9 presents the use of reversible watermarks with embedded additional content;

FIG. 10 presents the use of reversible watermarks with robust watermarks;

### DESCRIPTION OF PREFERRED EMBODIMENTS OF THE INVENTION

An important application of this invention is to add a perceptible, and in fact intrusive, watermark to media, which is freely distributed in order to encourage as many people as possible to sample it, and then decide to upgrade by removing the watermark, thus restoring the media to a high-quality version.

Although these watermarking techniques are sufficiently general and powerful that they can be applied to any form of digital media; in one embodiment, these are applied to frequency-domain-transformed data generated as part of the compression process, for example the DCT transformation used in many modem CODECs such as mp3 audio, MPEG video, JPEG pictures, etc. Such types of transformed data have unique qualities that make the present invention particularly useful with them, as is described later.

In one embodiment, the watermarking data can consist of random bit-values, in which case it will add some form of noise to the media. It can also consist of somewhat structured data. For example, in an audio application, a branded sequence of tones, embedded among other values, can signify the presence of a removable watermark. The addition of a voice prompt suggesting that the user purchase an upgraded version of the media is also possible, as is text or logos added to an image or video file.

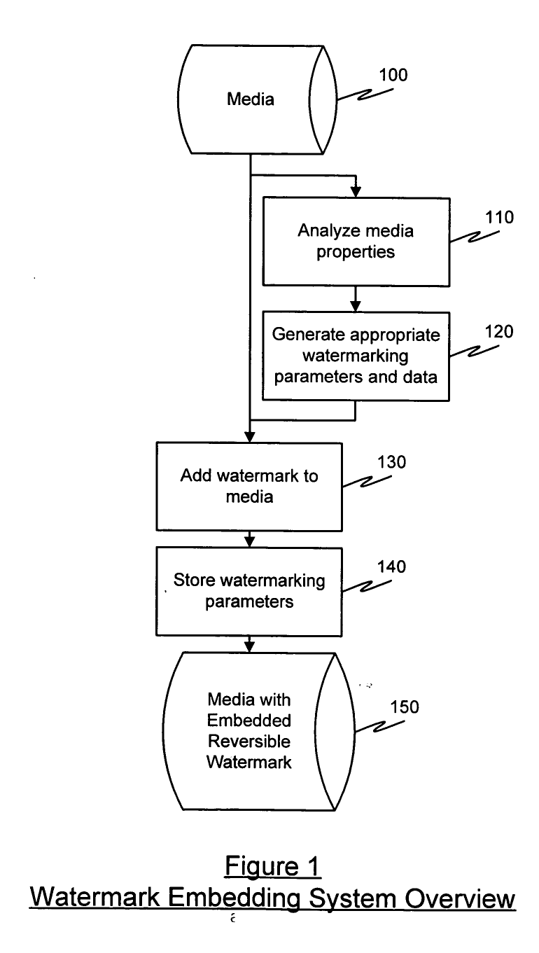

FIG. 1 is a block and flow diagram illustrating an overview of the watermark embedding process and system, operating in accordance with a preferred embodiment of the invention. In this figure, some media 100 to be encoded is analyzed 110 to determine which watermark parameters are best suited to adding perceptible distortion to the media. In step 120, a watermark is generated based on those parameters, and it is then 130 added to the media, using a reversible mathematical operation such as addition or XOR. These watermarking parameters are then stored 140, either packaged along with the media, in an encrypted form, or as part of the license information, in an external store.

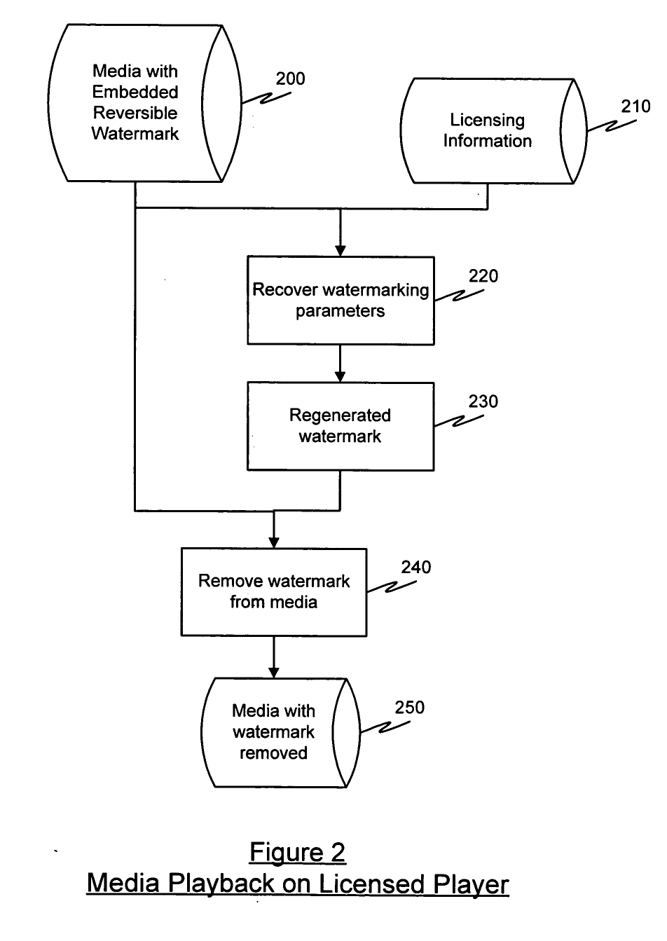

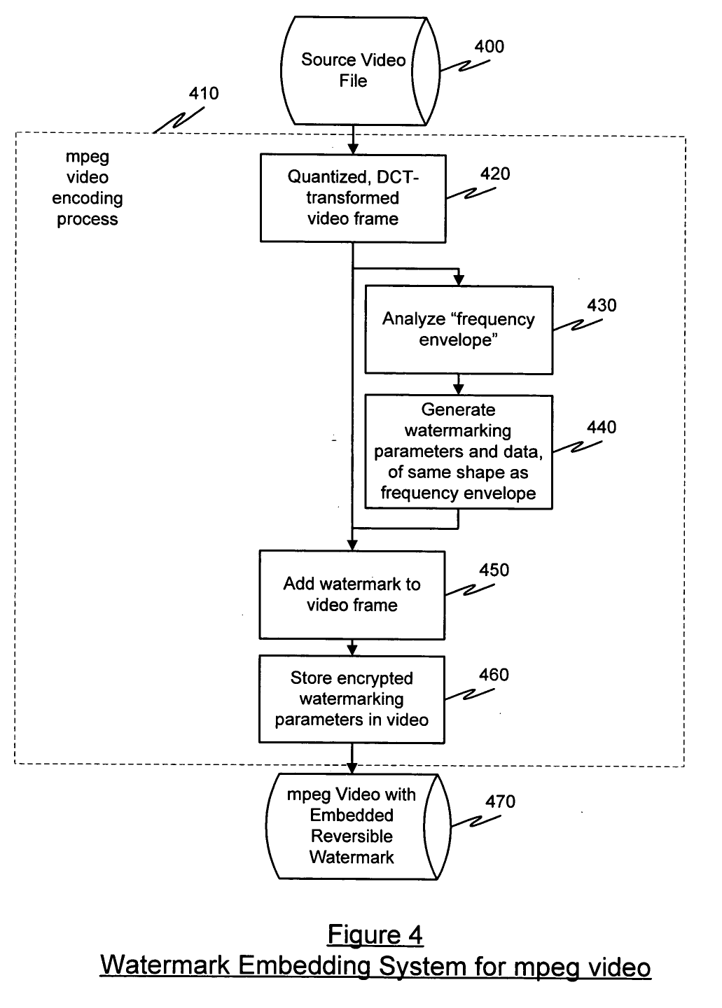

FIG. 2 is a similar diagram presenting an overview of the playback of the media embedded with the watermark of FIG. 1, on a licensed media player or viewer where the media 200 is to be restored to a high-quality version. Where it has been determined through other means that some media is properly licensed, such as by example means as those described in FIG. 4, licensing information 210 is used to retrieve the watermark parameters 220. In one embodiment, these parameters are packaged along with the media, in an encrypted form, so must be decrypted using the licensing information. In another embodiment, these parameters are packaged along with the licensing information when it is downloaded to the player. Using these watermark parameters, the watermark 230 is regenerated, in identical form to that created in the earlier encoding step 120. It is then removed 240 using the inverse mathematical operation to that used in step 130 (for addition, that would be subtraction, and for XOR, it would be XOR). This results in media 250 with the watermark thereby removed.

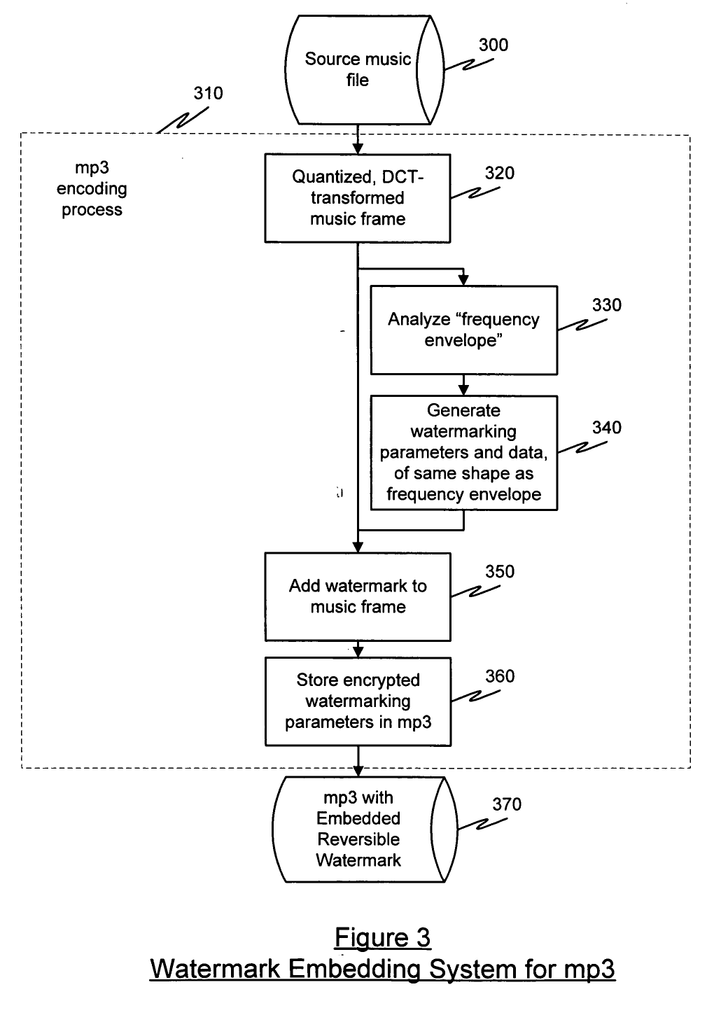

FIG. 3 is a modified version of FIG. 1, showing specifically how this invention works in one embodiment, namely using mp3 audio encoding, with the watermarking parameters stored within a second data channel of that mp3.

A source music file 300, such as a PCM-encoded CD-audio file, is processed by the mp3 compression algorithm as described in:
MPEG Spec-ISO/IEC 11172, part 1-3, Information Technology-Coding of moving pictures and associated audio for digital storage media at up to about 1.5 Mbit/s Copyright 1993, ISO/IEC.

As described in that specification, audio is broken down into 576-sample frames, and then each frame is transformed into the frequency domain using the Discrete Cosine Transform (DCT), and then scales those values using a scaling factor, resulting in some frequency values 320. This invention, in this embodiment, analyzes the resulting frequency values to generate a simpler parameterized representation of which frequency ranges have the most power, which we term a “frequency envelope” 330.

It should be noted that, if a watermarking that contains white noise is added to the frequency values of an mp3, this will automatically increase the compressed size, since that pollutes the higher-frequency values, making the music much harder to compress. In general, the mp3 codec adapts to this noise by decreasing the overall music quality to bring it back down to the same compressed size. In order to avoid this decrease in quality, it is necessary to compute a frequency envelope which restricts the added noise to having the same frequency characteristics.

The frequency ranges with such zero values vary from song to song and, in fact, from beat to beat, so a static approach will not work. The only way to properly embed reversible noise into an mp3, without degrading it by making the music more difficult to compress, is to dynamically compute a frequency envelope for each frame, which has the exact same frequency range as that frame, and which thus will tend to keep the compressed representation of that song about the same size.

In one embodiment, this frequency envelope comprises a concise description a few bytes long that describes the sizes of various sub-groups of frequencies within this block. Such a description is described in greater detail later in this document. A random number is used as a parameter for the seed to generate small watermarking values for each frequency of the frame. Where the intent is to mark the audio with random low-bit noise, this is a straightforward random generator. Where the intent is to mark the audio with a series of tones or other understandable content, the watermarking content is shaped by the randomly generated noise, so that the watermark is thereby difficult to remove. This watermarking content is then shaped by the parameters of frequency envelope so that the watermark impacts those areas of the music where there is already the most energy 340.

The watermarking noise is then combined 350 with the frequency values of that frame of music, in one embodiment by using the bit-wise XOR operation, which is easily reversible by re-applying it. In another embodiment, the watermarking noise is added to the frame of music, though any reversible mathematical operation can be used in this invention. Since it is possible for the combined new values to exceed the range of representation of values in this format, if this occurs, either the description of the frequency envelope can be amended to remove such values from the watermarking noise, or a new random seed can be chosen and the watermark re-applied until the combined new values no longer exceed the range of allowable representation.

Finally, the parameters necessary to regenerate the watermarking noise created the previous step are encrypted and stored in the mp3 360. These parameters may include: the random seed-value, the watermark envelope, an identifier for any understandable content added, and any areas excluded from watermarking, and are generally 4-12 bytes per frame. Any available encryption technique known to those skilled in the art can be used to encrypt these parameters, including but not limited to DES, IDEA, Blowfish, RSA, PGP, etc. In one embodiment, these parameters are stored using a second data channel, as described in our earlier cited U.S. Pat. Nos. 6,748,362 and 6,768,980. Alternatively, the data can be stored by placing it before a SYNC value, as described in the ID3v2 specification:

ID3v2 spec: http://www.id3.org/easy.html and http://www.id3.org/id3v2.3.0.html

The value may also be stored in the ancillary data field described in the mp3 specification, or can be stored at the end of the music file, after all frames of music. Any other mechanism in the format that provides for an additional channel of data may be used, for example when such audio is encapsulated within another media stream such as Quicktime or MPEG-4.

Finally, at the completion of the modified mp3 encoding process, the result is an mp3 with an embedded reversible watermark 370.

These same and similar techniques can be used by one skilled in the art to apply this technique to any audio compression format, including but not limited to the well known AAC, ATRAC, ADPCM, GSM, CDMA, etc. formats. We briefly outline the main modifications to the approach necessary for each class of formats:

Frequency-domain formats, such as AAC, ATRAC, etc., all use the same basic series of steps (with perhaps other transforms than the DCT transform used in mp3 used to transform into the frequency domain) outlined in FIGS. 1 and 3, so this basic process can be used with only minimal changes.

In signal-domain formats, such as ADPCM and PCM, etc., the noise is added in the signal domain of the audio signal. In such a case, the DCT transform is not part of the encoding process, but a frequency transform may still be used as part of the process to determine the amount of noise to add to the audio to ensure that it is perceptually significant.

In a vocoder format, such as GSM or CDMA, the analysis process, instead of using a frequency transform, uses the characteristics of the vocoder parameters to determine how to add perceptually significant noise to the signal, and then such watermarking noise is added to selected vocoder parameters.

FIG. 4 is a modified version of FIG. 1, showing specifically how this invention works in another embodiment, namely MPEG video encoding. Internet-based video distribution through mechanisms such as BitTorrent and direct peer-to-peer mechanisms such as Bluetooth and 802.11 is becoming increasingly economically significant. Therefore, a system for providing for a low-quality preview version of a video, which can then be upgraded to a high-quality version suitable for viewing, is quite useful. Note that this embodiment of adding a reversible watermark to video is easily combined in the same system with the embodiment described in FIG. 3, which adds a reversible watermark to audio, and such a system is of great combined utility, since video generally is distributed with an accompanying audio track.

A source video file 400, such as a DV-encoded video file, is processed by the MPEG video compression algorithm as described in the previously referenced MPEG Spec-ISO/IEC 11172, part 1-3.

In the MPEG encoding process 410, a sequence of video frames is compressed into multiple types of frames: I, B, and P frames. Intra-coded, or I-coded frames are stand-alone frames, coded without respect to other frames. Predictive-coded, or P-coded frames provide for motion-compensated prediction from an I or another P frame. Bidirectionally-coded, or B-coded frames sit between two I or P frames, and provide forward and backward prediction relative to an I or P frame. Regardless of the type of frame, blocks within the frame are encoded using similar techniques. A frame of video is broken down a macroblock, which contains six 8 by 8 blocks of pixels. Four of these represent Y, or luminance values for a region, and the other two represent Cb and Cr chrominance, respectively. Each of these blocks is processed in the same way, by transforming this 8 by 8 block of values using the DCT transform, scaling it by a scaling factor, and then scanning it in zig-zag order to generate a one-dimensional array of coefficients, resulting in some frequency values 420.

As in FIG. 3, this invention analyzes the resulting frequency values in each block to generate a simpler parameterized representation of the frequency envelope 430. For the same reasons described previously, it is necessary to compute a frequency envelope which restricts the added noise to having the same frequency characteristics.

A random number is used as a parameter for the seed to generate small watermarking values for each frequency of the video frame. Where the intent is to mark the video with random low-bit noise, this is a straightforward random generator. Where the intent is to mark the video with a series of recognizable shapes such as letters, the watermarking content is shaped by the randomly generated noise, so that the watermark is thereby difficult to remove. This watermarking content is then shaped by the parameters of frequency envelope so that the watermark impacts those areas of the video where there is already the most energy 440.

The watermarking noise is then combined 450 with the frequency values of that frame of video, using techniques previously described with step 350. And finally, these parameters are encrypted and stored in the video 460, as described in the previous step 360.

Finally, at the completion of the modified MPEG video encoding process, the result is an MPEG video with an embedded reversible watermark 470.

These same and similar techniques can be used by one skilled in the art to apply this technique to any video compression format, including but not limited to the well known MPEG-2, MPEG-4, H.264, VC-1, etc. formats. Because such approaches typically use very similar techniques to that used in the MPEG format, they are straightforward for someone skilled in the art to apply.

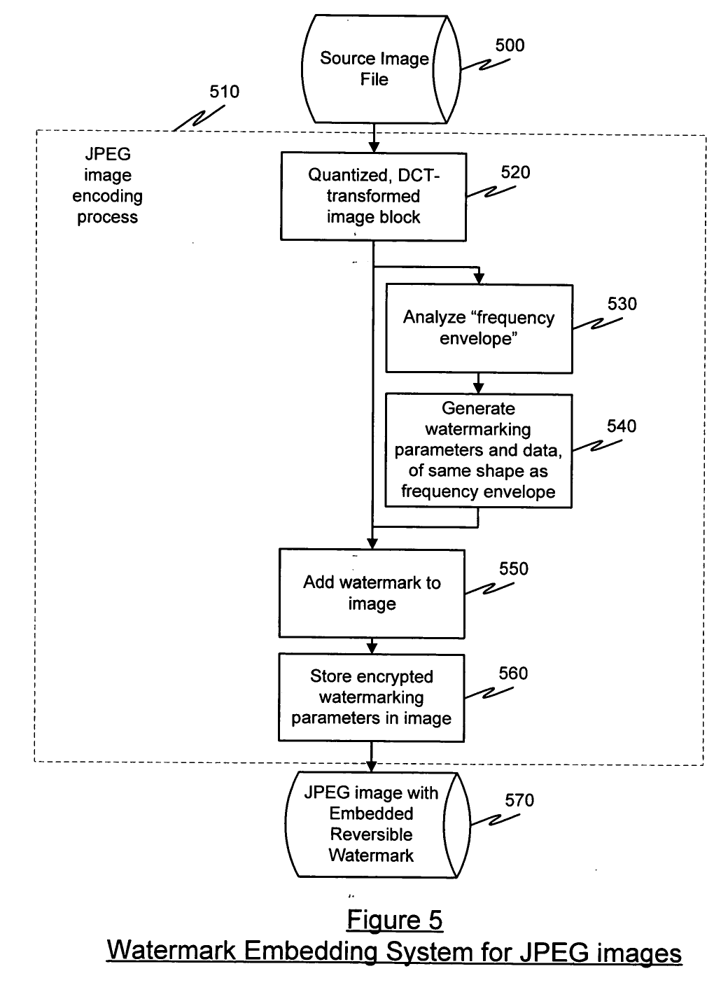

FIG. 5 is a modified version of FIG. 1, showing specifically how this invention works in one embodiment, namely JPEG image encoding, described in JPEG Spec-ISO/IEC IS 10918-1|ITU-T Recommendation T.81, parts 1-4. Since this process is very similar to that described in the video encoding process in FIG. 4, it will be described very concisely, with reference to the preceding examples.

A source image 500, such as a raw image file, is processed by the JPEG image compression algorithm 510. The JPEG algorithm contains several types of encoding schemes, but in the most commonly used in, as in the MPEG algorithm, an image is transformed into a different color space, in this case YUV. Each 8×8 block of Y values forms a block, and depending on the downsampling technique used, 8×8 blocks of U and V values are created by scaling from either 8×16 or 16×16 blocks of U and V values. Each of these blocks is processed in the same way, by transforming this 8 by 8 block of values using the DCT transform, scaling it by a scaling factor, and then scanning it in zig-zag order to generate a one-dimensional array of coefficients, resulting in some frequency values 520.

Frequency value analysis and watermarking proceed in steps 530 and 540, as in the previously described steps 430 and 440, respectively.

The watermarking noise is then combined 550 with the frequency values of that image, as in the previous step 450. And finally, these parameters are encrypted and stored in the video 560, as described in step 460. The result is an JPEG image with an embedded reversible watermark 470.

These same and similar techniques can be used by one skilled in the art to apply this technique to any image compression format. Because such approaches typically use very similar techniques to that used in the JPEG format, they are straightforward for someone skilled in the art to apply.

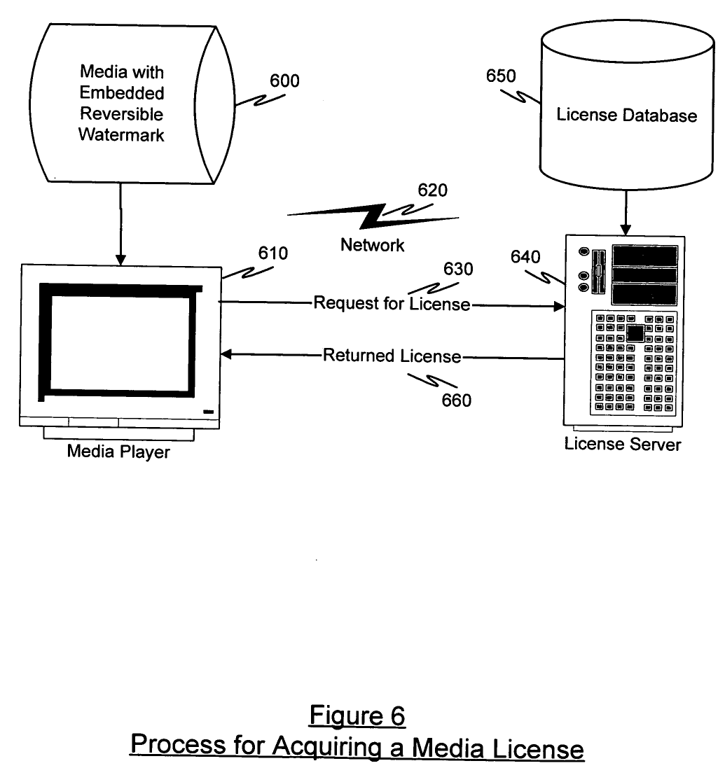

FIG. 6 illustrates a simple protocol showing how the licensing process takes place. A very detailed description of this protocol is beyond the scope of this invention, but one possible framework for quickly building such protocols is BEEP, described in:
Rose, Marshall T., BEEP: The Definitive Guide: Developing New Applications for the Internet, O'Reilly Publishing, March 2002, ISBN: 0-596-00244-0.

Media containing an embedded reversible watermark 600 is played on a Media Player 610, consisting of, for example, a computer device, a portable media player, or a portable gaming device. When this media is played on the Media Player and the user does not already have a license for that content, the user is presented with the option to upgrade that content by requesting a license to play that content at full quality. Such a license is requested by using a Network 620 to send the Request for License 630, which contains but is not limited to such information as the identifier of the media, the type of license requested, payment information if needed, and the device or devices for which the license is requested. This is sent to one or more License Servers 640, which are able to query the License Database 650 for the necessary information. The Returned License 660 contains all necessary information to remove the watermark. For cases where the watermarking parameters are stored in encrypted form inside the media, this may consist solely of a decryption key to decrypt said parameters. In other cases where it is not suitable to store these watermarking parameters inside the media, the License Database can contain these watermarking parameters and return them as part of the Returned License. In either case, the result is that the media player uses the process described in FIG. 2 to remove the watermark from the content, temporarily or permanently, depending on the license, so that the user is able to play the content at full quality.

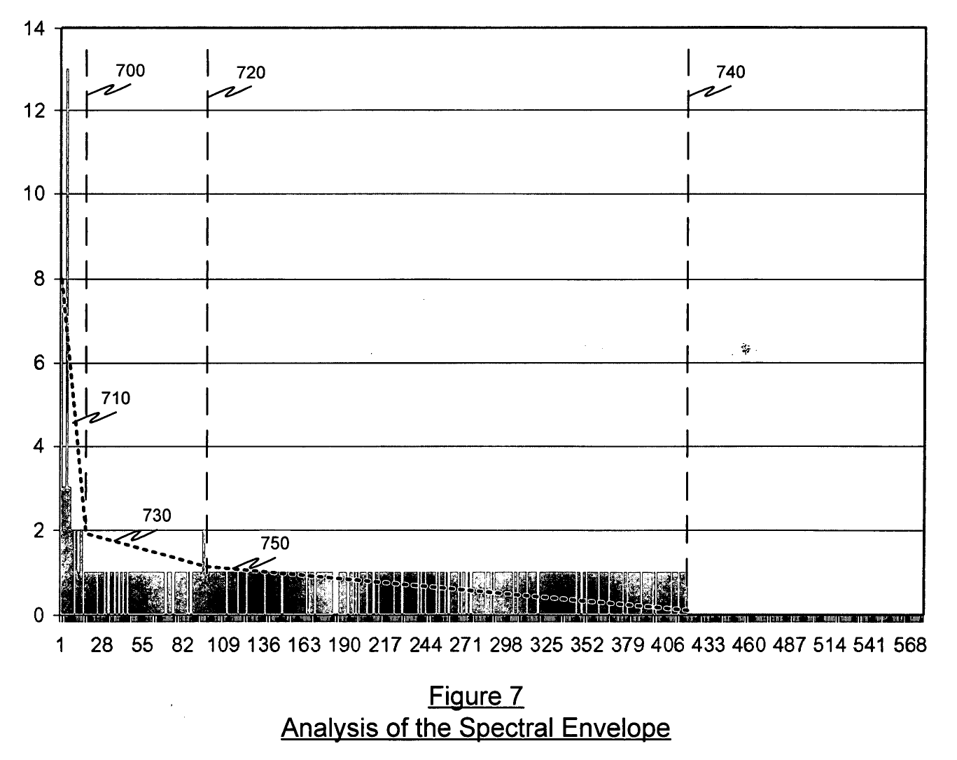

FIG. 7 illustrates the analysis of the spectral envelope when this invention is used with frequency-domain codecs such as mp3, MPEG, and JPEG. This particular example is derived from the DCT transformation of a frame from an actual mp3 file, Natalie Merchant's “Jealousy.” In this frame, there is an area 700 up until about the 15th coefficient which has values peaking at 13, and which are consistently larger than one. This area should have a large amount of noise added in it, so envelope 710 designates that. After the 96th coefficient 720, no values are larger than one, so envelope 730 designates this region. After the 418th coefficient 740, all values are zero, so envelope 750 designates the region where much less noise should be added.

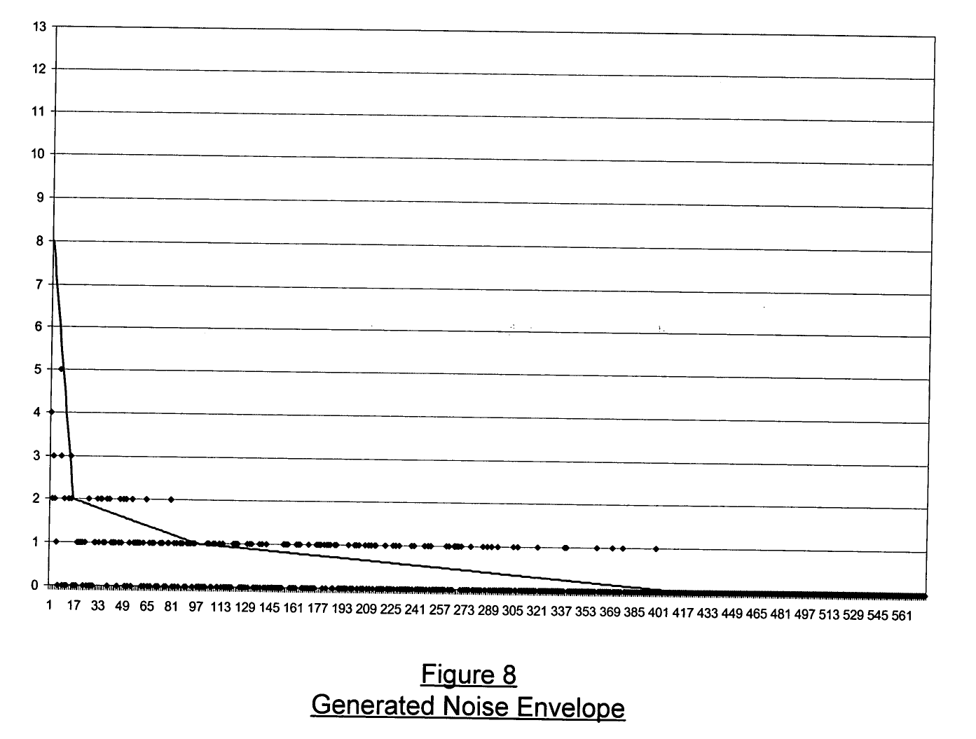

FIG. 8 shows how the analysis of FIG. 7 is used to create an appropriate watermarking signal that will not greatly affect the compression process of frequency-domain codecs. In the figure, small diamonds represent the noise value to be inserted at that coefficient. Since coefficients are stored as integers, noise values are limited to integral amounts. Therefore, the envelope is used to create a probability distribution that noise will be added at that element. Because of this, some elements may lie outside of the noise envelope, but the probability of that drops off correspondingly as the envelope drops off.

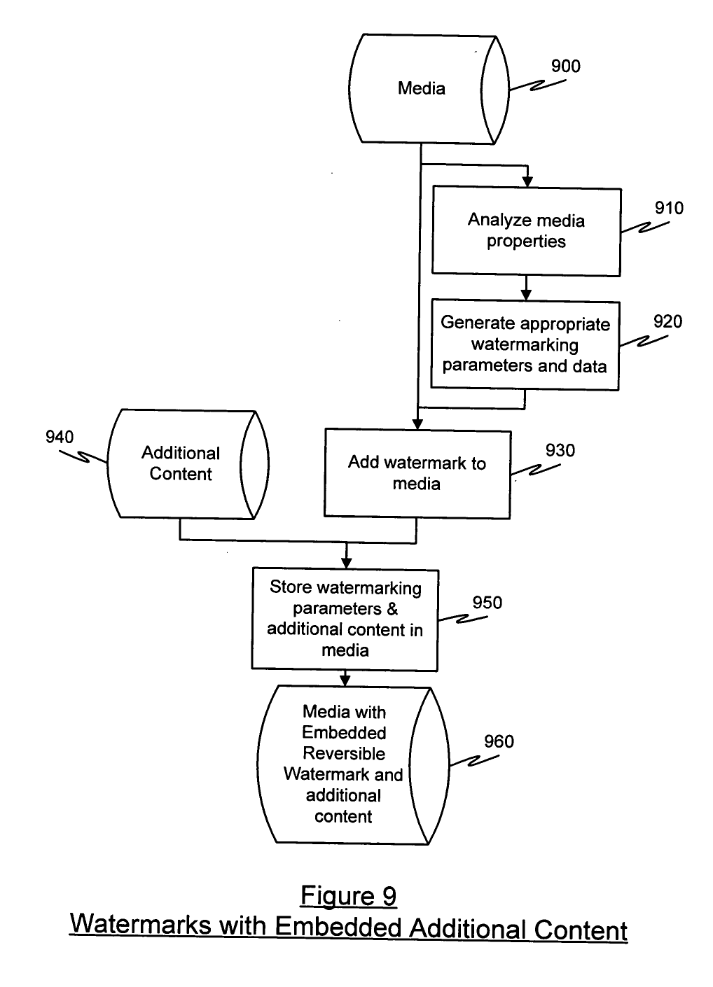

FIG. 9 is a modified version of FIG. 1, presenting the use of reversible watermarks with embedded additional content. This allows for the useful functionality wherein a user is only permitted to play high-quality media if the user is willing to play additional content at the same time; examples of such additional content include but are not limited to advertising, merchandising, polls, and interactive games. Steps 900-930 are identical to the corresponding steps in FIG. 1. Additional Content 940 is stored in the media, in a similar way to how the watermarking parameters are stored 950, through any of a number of well-known mechanisms which support an additional data channel, such as those described in our earlier-mentioned U.S. Patents. This results in Media with an Embedded Reversible Watermark and Additional Content 960.

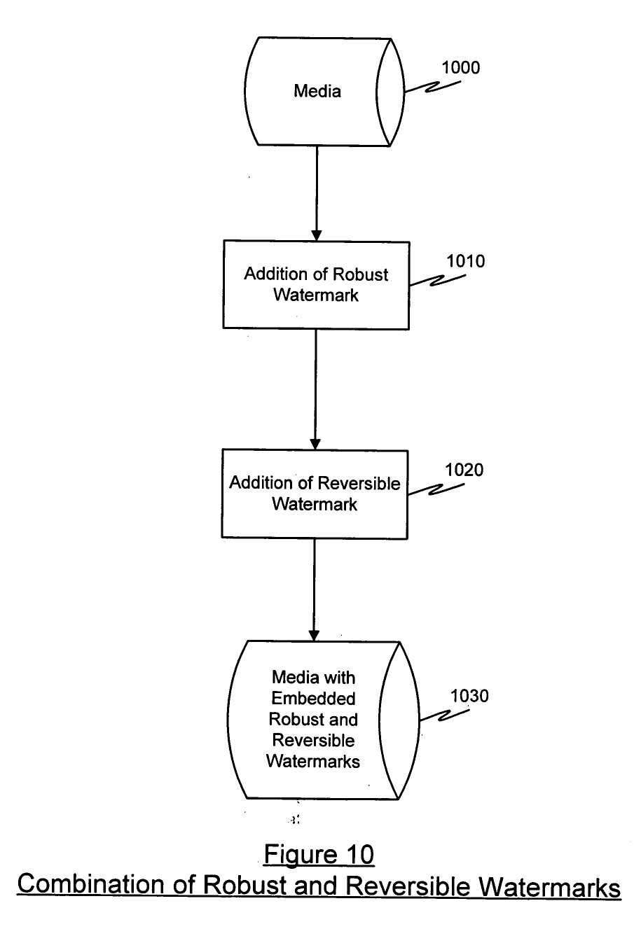

FIG. 10 presents the use of reversible watermarks in conjunction with robust watermarks. Typically, a robust but unapparent watermark is added to a media file in order to facilitate the tracking of that content and enforcement of licensing schemes. Such an approach is useful also with the system of the invention, since the robust watermark will remain in the media file, even after the reversible watermark has been removed. This is done through Media 1000, first being marked using a Robust Watermarking process 1010, such as those developed as part of the SDMI initiative. Following this, the techniques described previously are applied to add a Reversible Watermark 1020 to the file, resulting in Media with Embedded Robust and Reversible Watermarks 1030. This works because a sufficiently robust watermark should be unaffected by the addition of the reversible watermark of the invention.

Further modifications will also occur to those skilled in this art, and such are considered to fall within the spirit and scope of the present invention as defined in the appended claims.

What is claimed is:

1. A method of reversibly adding watermarking data to compressed high-quality digital media files, that comprises,
analyzing the media file data to determine suitable watermarking parameters sensitive to the dynamics of the data;
creating an apparent, audible and user-intrusive watermark based on such parameters;
adding such watermark to the media file and encoding the same into the media file using a reversible mathematical operation to degrade quality;
regenerating the watermark; and
reversing said mathematical operation, upon a user of the media file with its degrading watermarking subscribing for a license, thereby to remove the watermark from the media file and restore its high-quality.

2. The method of claim 1 wherein the media file is a music data file and said parameters are sensitive to the dynamics of music.

3. The method of claim 1 wherein the digital media comprise frequency-domain-transformed data generated as part of the compression.

4. The method of claim 3 wherein the transform data is DCT transformation.

5. The method of claim 1 wherein the watermarking data is selected from the group consisting of noise, pseudorandom noise, random bit-value noise, sequences of tones, and voice prompts urging the user to upgrade through removal of the watermark.

6. The method of claim 1 wherein the mathematical operation is one of addition and XOR.

7. The method of claim 2 wherein the media data is of MP3 format and a frequency envelope is computed to restrict added noise watermarking to having the same or similar frequency characteristics.

8. The method of claim 7 wherein the completion of the MP3 encoding process results in an MP3 with an embedded reversible watermark.

9. The method of claim 5 wherein the compressed digital media file is selected from the group consisting of MP3 audio, MPEG video, and JPEG pictures.

10. The method of claim 9 wherein parameters necessary to request the watermarking noise are encrypted and stored in a data channel containing, also, embedded rich media such as advertisements, transactions, and interactive music videos.

11. The method of claim 2 wherein the user is permitted a short time of high-quality listening until the watermark degrading sets in, to permit a decision to purchase a license.

12. Apparatus for reversibly adding watermarking data to compressed high-quality digital media files, having, in combination,
means for analyzing the media file data to determine suitable watermarking parameters sensitive to the dynamics of the data;
means for creating an apparent, audible and user-intrusive watermark based on such parameters;
means for adding such watermark to the media file and encoding into the media file using a reversible mathematical operation to degrade the quality;
regenerating the watermark; and
reversing said mathematical operation, upon a user of the media file with its degrading watermarking subscribing for a license, thereby to remove the watermark from the media file and restore its high-quality.

13. The apparatus of claim 12 wherein the media file is a music data file and said parameters are sensitive to the dynamics of music.

14. The apparatus of claim 12 wherein the digital media comprise frequency-domain-transformed data generated as part of the compression.

15. The apparatus of claim 14 wherein the transform data is DCT transformation.

16. The apparatus of claim 12 wherein the watermarking data is selected from the group consisting of noise, pseudorandom noise, random bit-value noise, sequences of tones, and voice prompts, including urging the user to upgrade through removal of the watermark.

17. The apparatus of claim 12 wherein the mathematical operation is one of addition and XOR.

18. The apparatus of claim 13 wherein the media data is of MP3 format and a frequency envelope is computed to restrict added noise watermarking to having the same or similar frequency profile characteristics.

19. The apparatus of claim 18 wherein the completion of the MP3 encoding process results in an MP3 with an embedded reversible watermark.

20. The apparatus of claim 16 wherein the compressed digital media file is selected from the group consisting of MP3 audio, MPEG video, and JPEG pictures.

21. The apparatus of claim 20 wherein parameters necessary to request the watermarking noise are encrypted and stored in a media data channel.

22. The apparatus of claim 21 wherein the data channel for storage is a second data channel containing, also, embedded rich media such as advertisements, transactions, and interactive music videos.

23. The apparatus of claim 13 wherein means is provided to permit-the user a short time of high-quality listening until the watermark degrading sets in, in order to permit a decision to purchase a license.

24. The apparatus of claim 12 wherein means is provided for adding a permanent, non-apparent and robust further watermark to the media file, unaffected by the addition or removal of the reversible watermark.

25. The apparatus of claim 12 wherein the reversible watermarking signal minimally affects the compression process of the digital media files.

26. The apparatus of claim 12 wherein the media is an MPEG video file compressed into multiple types of frames, and the watermarking content comprises randomly generated noise shaped by the parameters of a frequency envelope impacting those areas of the video where the most energy lies.

27. The apparatus of claim 12 wherein means is provided for encrypting and storing the parameters necessary to regenerate the watermark.

28. The apparatus of claim 27 wherein said parameters include one or more of random seed-value, watermark envelope, and an identifier for any understandable content added.
